(19) United States
(12) Patent Application Publication
(10) Pub. No.: US 2014/0139468 A1
(43) Pub. Date: May 22, 2014

(54) TOUCH DISPLAY PANEL MODULE AND ASSEMBLY METHOD THEREOF

(71) Applicants: WINTEK CORPORATION, Taichung City (TW); Dongguan Masstop Liquid Crystal Display Co., Ltd., Dongguan City (CN)

(72) Inventors: Hui-Chien Chen, Changhua County (TW); Tsung-Yi Lin, Taichung City (TW); Ming-Chuan Lin, Taichung City (TW); Shih-Cheng Wang, Changhua County (TW)

(73) Assignees: WINTEK CORPORATION, Taichung City (TW); Dongguan Masstop Liquid Crystal Display Co., Ltd., Dongguan City (CN)

(21) Appl. No.: 14/085,818

(22) Filed: Nov. 21, 2013

(30) Foreign Application Priority Data
Nov. 22, 2012 (TW) 101143668

(51) Int. Cl. G06F 3/041; B29D 11/00

(52) U.S. Cl. CPC G06F 3/041; B29D 11/0073
USPC 345/173; 156/242

(57) ABSTRACT

A touch display panel module includes a display panel module, a touch panel module, and a combining unit. The display panel module is for displaying images, and the display panel module has a first side, a second side opposite to the first side and a plurality of lateral sides between the first side and the second side. The touch panel module is disposed on the first side of the display panel module for sensing touch input. The combining unit includes an anti-permeation tape and an optical adhesive layer. The anti-permeation tape continuously covers on at least one of edges around the first side of the display panel module. The optical adhesive layer is formed between the display panel module and the touch panel module for combining the display panel module and the touch panel module.

### BACKGROUND OF THE INVENTION

1. Field of the Invention

The present invention relates to a touch display panel module and an assembly method thereof, in particular, to a touch display panel module capable of preventing optical adhesive from permeating into a display panel and an assembly method thereof.

2. Description of the Prior Art

As related technology keeps improving, many kinds of input devices and input methods are gradually developed, in which touch input technology is the most widely accepted input method to consumers. The touch input technology generates touch signals by sensing motion of a finger of a user on a touch display panel, and an electronic device then determines a command inputted by the user to operate according to the touch signals. Therefore, the electronic device with the touch display panel requires fewer physical buttons, or even requires no physical buttons to input.

The current touch display panel module is usually made by attaching a touch panel module to a display panel module. In order to increase transmittance between the touch panel module and the display panel module, the touch panel module and the display panel module are combined by liquid optical adhesive. However, the liquid optical adhesive has better liquidity, such that when combining the touch panel module and the display panel module, the liquid optical adhesive may overflow and permeate into gaps inside the display panel module from joint areas outside the display panel module. For example, the liquid optical adhesive may permeate into a gap between a display panel and a backlight module due to the capillary phenomenon. The above situation may affect distribution of backlight, such that brightness of images is uneven, and image quality of the touch display panel module is seriously worsened.

### SUMMARY OF THE INVENTION

The present invention provides a touch display panel module. The touch display panel module comprises a display panel module, a touch panel module, and a combining unit. The display panel module is for displaying images, and the display panel module has a first side, a second side opposite to the first side and a plurality of lateral sides between the first side and the second side. The touch panel module is disposed on the first side of the display panel module for sensing touch input. The combining unit comprises an anti-permeation tape, and an optical adhesive layer. The anti-permeation tape continuously covers on at least one of edges around the first side of the display panel module. The optical adhesive layer is formed between the display panel module and the touch panel module for combining the display panel module and the touch panel module.

The present invention further provides an assembly method of a touch display panel module. The method comprises providing a display panel module and a touch panel module, the display panel module having a first side, a second side opposite to the first side and a plurality of lateral sides between the first side and the second side; continuously covering all edges around the first side of the display panel module with an anti-permeation tape; forming a layer of liquid optical adhesive between the first side of the display panel module and the touch panel module; and solidifying the layer of liquid optical adhesive in order to combine the display panel module and the touch panel module.

In contrast to the prior art, the touch display panel module of the present invention continuously covers all edges around the first side of the display panel module with the anti-permeation tape, and entirely or partially covers lateral sides and a second side of the display panel module with the anti-permeation tape, such that when assembling the touch display panel module, liquid optical adhesive cannot permeate inside through joint areas outside the display panel module. The assembly method of the touch display panel module of the present invention can prevent the liquid optical adhesive from permeating into gaps between a display panel and a backlight module due to the capillary phenomenon, and further increases assembly yield rate and efficiency of the touch display panel module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view a touch display panel module of the present invention.

FIG. 2 is a diagram showing an anti-permeation tape covering the first side of the display panel module.

FIG. 3 is a diagram showing the spacers being arranged on the first side of the display panel module.

FIG. 4 is a diagram showing the optical adhesive layer being formed on the first side of the display panel module.

FIG. 5 is a diagram showing a first embodiment of the anti-permeation tape of the present invention.

FIG. 6 is a diagram showing a second embodiment of the anti-permeation tape of the present invention.

FIG. 7 is a diagram showing a third embodiment of the anti-permeation tape of the present invention.

FIG. 8 is a flowchart 800 showing an assembly method of the touch display panel module of the present invention.

### DETAILED DESCRIPTION

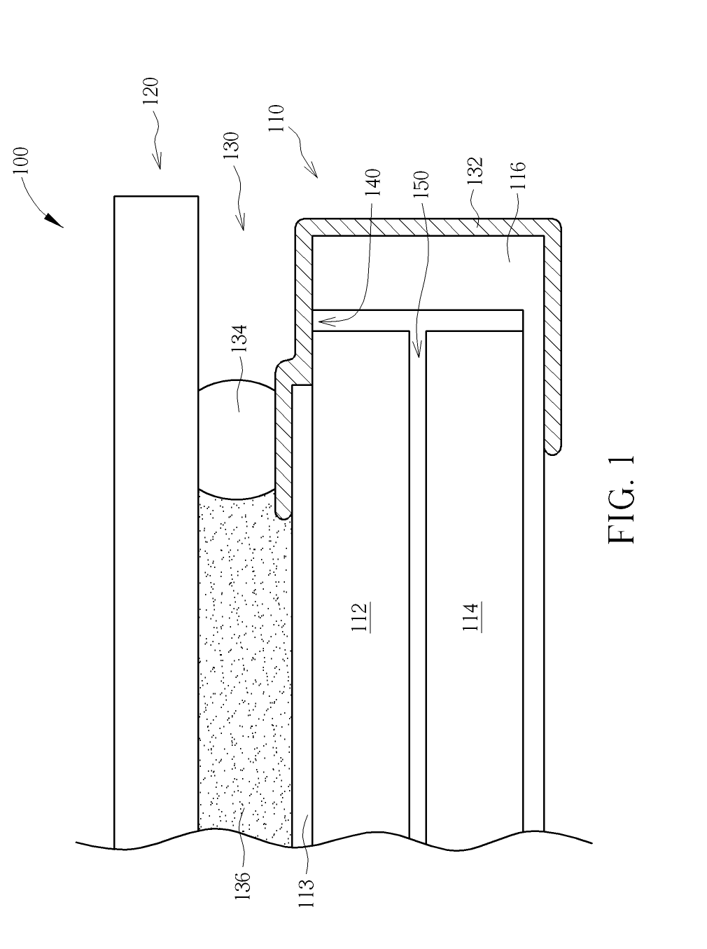

Please refer to FIG. 1. FIG. 1 is a cross-sectional view a touch display panel module of the present invention. As shown in FIG. 1, the touch display panel module 100 of the present invention comprises a display panel module 110, a touch panel module 120, and a combining unit 130. The display panel module 110 is for displaying images. The display panel module 110 comprises a display panel 112, a backlight module 114, and a frame 116. The backlight module 114 is arranged behind a second side (back side) of the display panel 112. The frame 116 is for positioning the display panel 112 and the backlight module 114. The touch panel module 120 is disposed on a first side (front side) of the display panel module 110 for sensing touch input. The combining unit 130 is for combining the display panel module 110 and the touch panel module 120. The combining unit 130 comprises an anti-permeation tape 132, a plurality of spacers 134, and an optical adhesive layer 136. The optical adhesive layer 136 is formed by solidifying liquid optical adhesive.

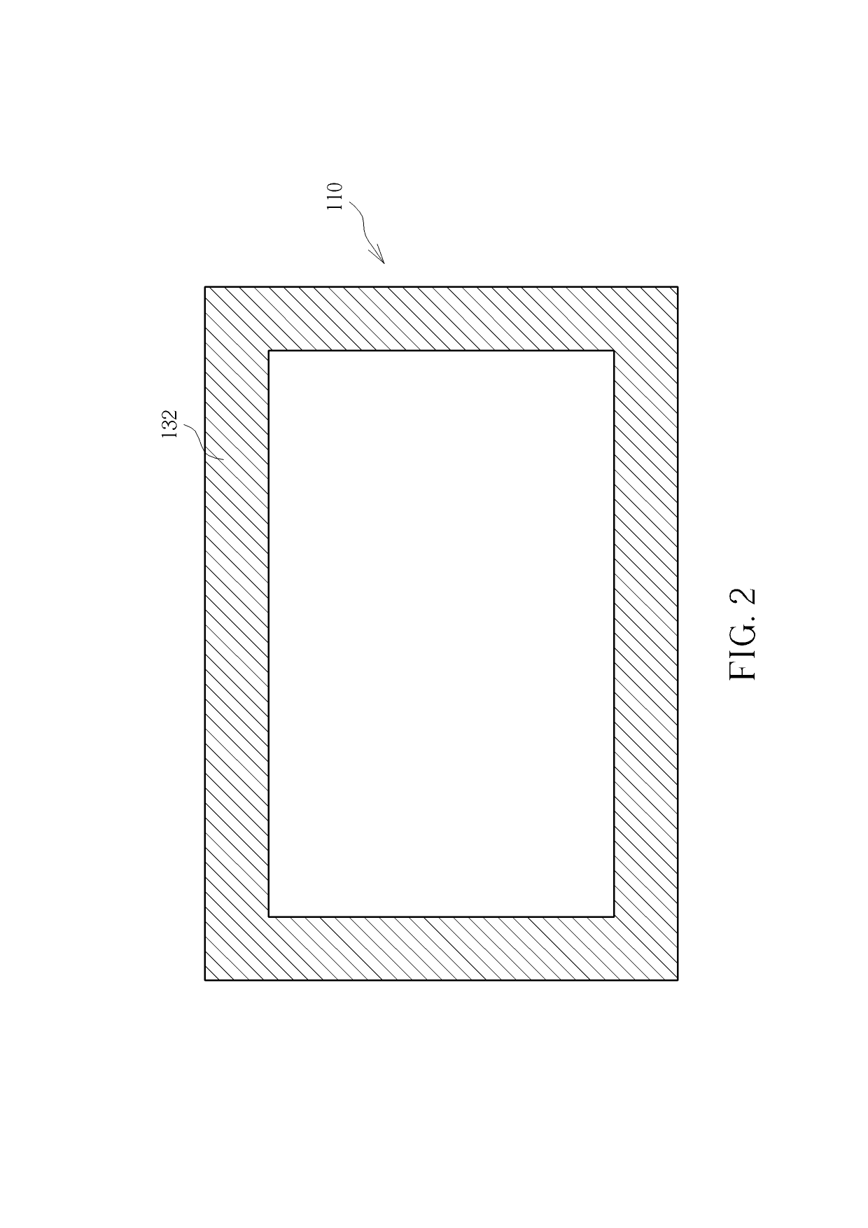

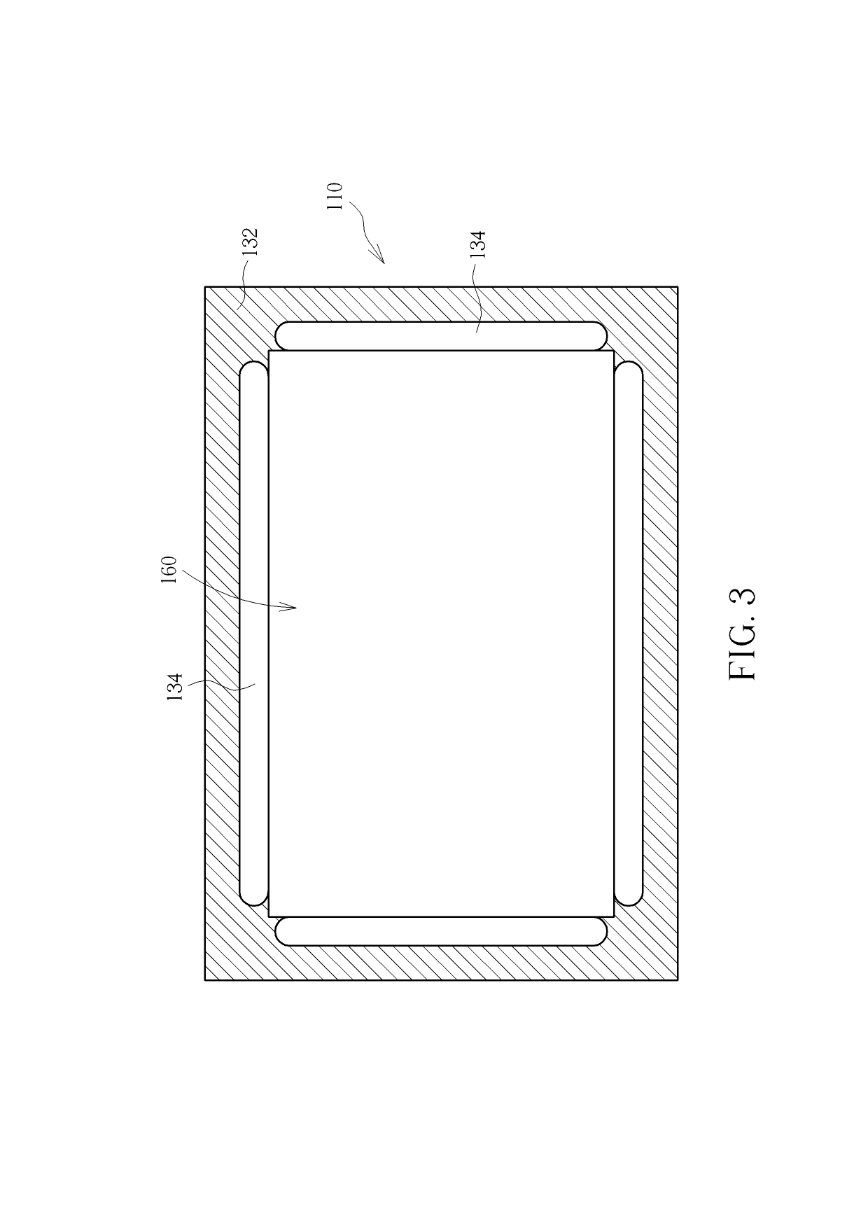

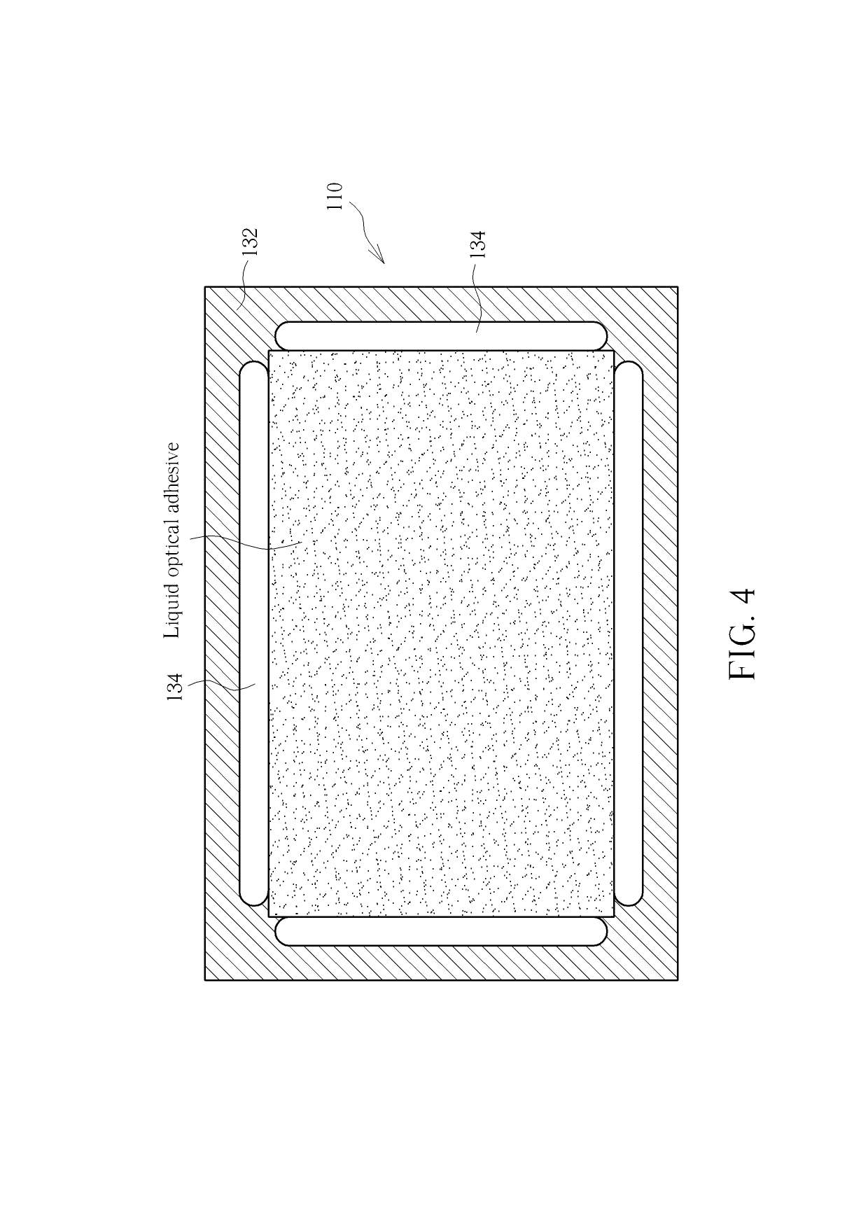

Please refer to FIG. 2 to FIG. 4, and refer to FIG. 1 as well. FIG. 2 is a diagram showing an anti-permeation tape covering the first side of the display panel module. FIG. 3 is a diagram showing the spacers being disposed on the first side of the display panel module. FIG. 4 is a diagram showing the optical adhesive layer being formed on the first side of the display panel module. As shown in FIG. 2, for arranging the combining unit 130, the anti-permeation tape 132 is first utilized to continuously cover all edges around the first side of the display panel module 110, and may also cover a periphery of an upper polarizer 113 on a surface of the display panel module 110, so as to continuously cover all joint areas 140 between the first side of the display panel 112 and the frame 116. Therefore, the liquid optical adhesive cannot permeate inside through the joint areas 140 between the first side of the display panel 112 and the frame 116 in order to prevent the liquid optical adhesive from flowing into gaps 150 between the display panel 112 and a backlight module 114 due to the capillary phenomenon. In addition, the anti-permeation tape 132 can entirely or partially cover lateral sides and the second side of the display panel module 110 according to design requirements, so as to prevent the liquid optical adhesive from permeating inside. As shown in FIG. 3, the plurality of spacers 134 are disposed on the anti-permeation tape 132 for forming an accommodation space 160 between the display panel module and the touch panel module in order to accommodate the liquid optical adhesive. In addition, the plurality of spacers 134 have gap between them for allowing excess liquid optical adhesive to flow out of the accommodation space 160 during assembly. The plurality of spacers 134 can be formed by optical adhesive with higher viscosity. As shown in FIG. 4, after completing arrangement of the spacers 134, a layer of the liquid optical adhesive is filled in the accommodation space 160. Finally, the touch panel module 120 is placed on the liquid optical adhesive as shown in FIG. 1, and the display panel module 110 and the touch panel module 120 are combined by solidifying the liquid optical adhesive to form the optical adhesive layer 136.

According to the above arrangement, when the touch panel module 120 is placed on the liquid optical adhesive to force the excess liquid optical adhesive to flow out of the accommodation space 160 from the gaps between the spacers 134, since the anti-permeation tape 132 covers on all of the joint areas 140 between the display panel 112 and the frame 116 as well as covers on the lateral sides and second side of the display panel module 110 entirely or partially, the liquid optical adhesive is not able to flow inside the display panel module 110 from the joint areas, so as to prevent the liquid optical adhesive from flowing into the gaps 150 between the display panel 112 and the backlight module 114 due to the capillary phenomenon. Wherein, the spacers 134 is not necessary in the present invention, the accommodation space 160 can be directly formed by the anti-permeation tape 132 for accommodating the optical adhesive layer 136 to combine the touch panel module 120 and the display panel module 110.

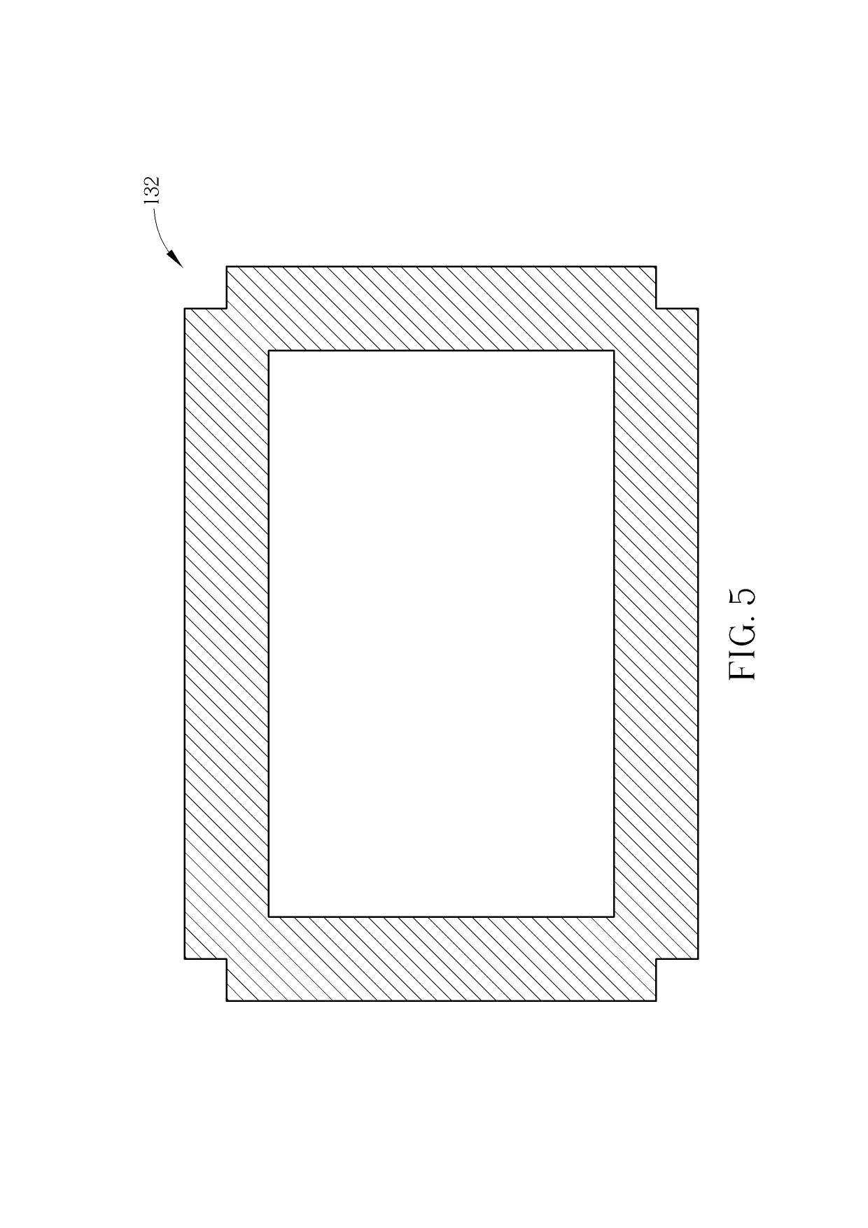

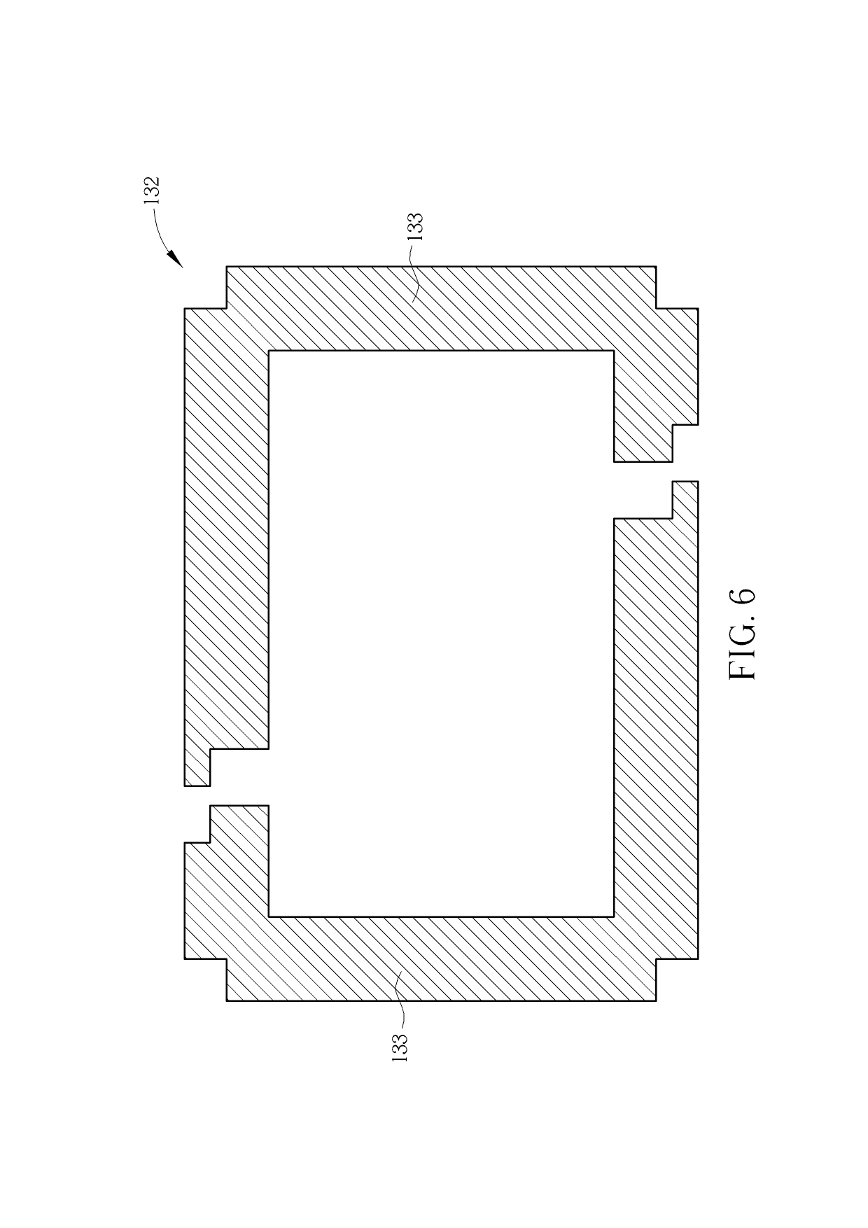

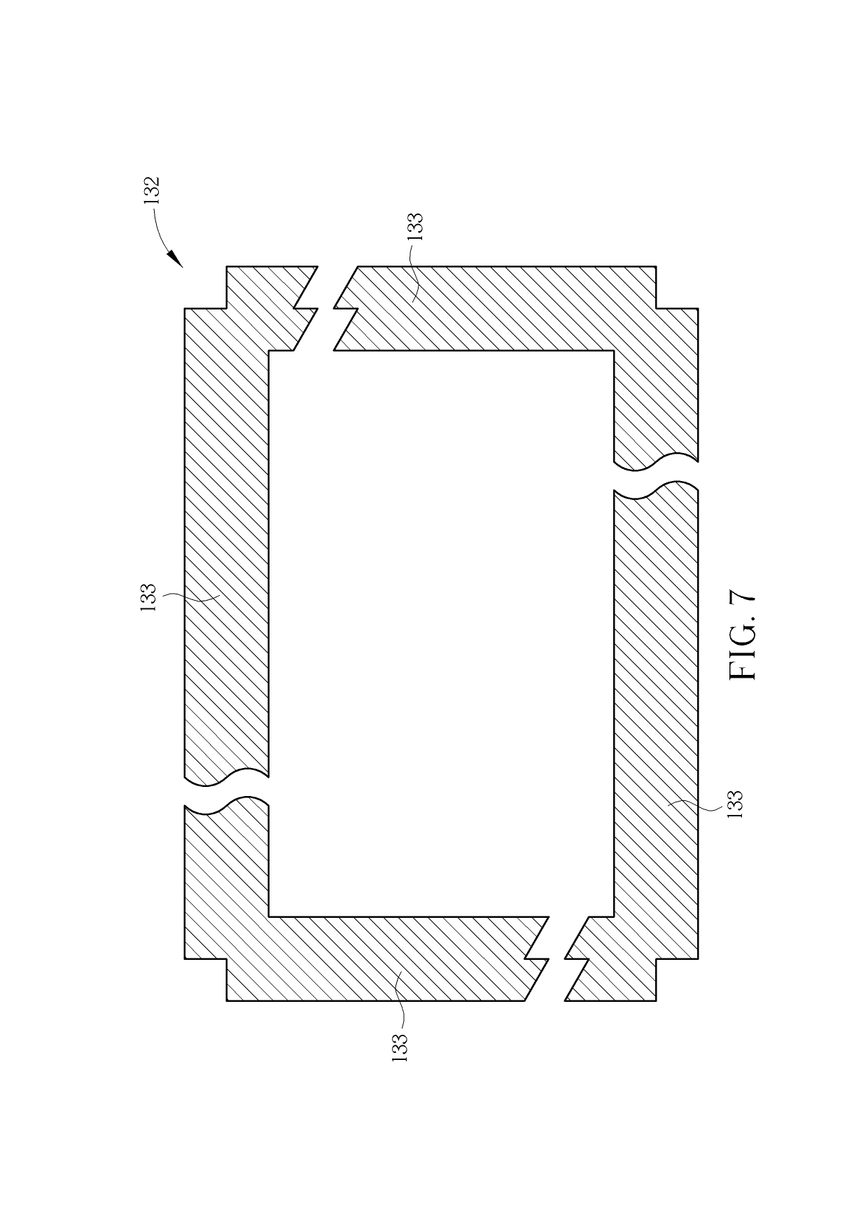

Please refer to FIG. 5 to FIG. 7. FIG. 5 is a diagram showing a first embodiment of the anti-permeation tape of the present invention. FIG. 6 is a diagram showing a second embodiment of the anti-permeation tape of the present invention. FIG. 7 is a diagram showing a third embodiment of the anti-permeation tape of the present invention. As shown in FIG. 5, the anti-permeation tape can be a hollow rectangular-shaped monolithic tape. Or, as shown in FIG. 6 and FIG. 7, the anti-permeation tape can be formed by combining a plurality of sub tapes 133. Especially, joint areas between the plurality of sub tapes 133 are disposed at positions different from four corner positions of the first side of the display panel module 110, so as to prevent the sub tapes 133 from disjointing at turning point of the corner position. In addition, the sub tapes 133 are overlapped with each other at the joint areas, and overlap width between two sub tapes is less than 2 mm. Moreover, the joint areas between the sub tapes is not necessary to be straight, for example, the joint area can be step-shaped, S-shaped, zigzag-shaped or irregular- shaped, so as to further prevent the liquid optical adhesive from permeating.

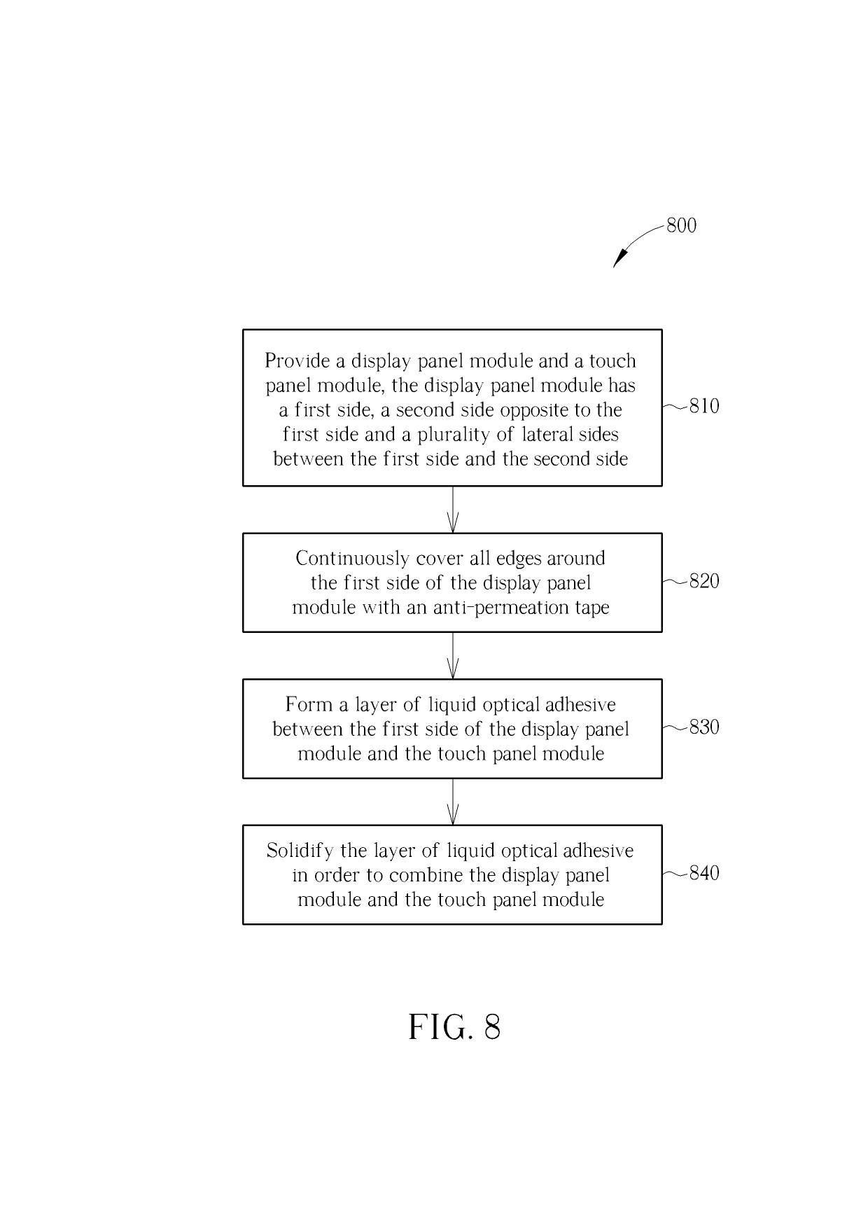

Please refer to FIG. 8. FIG. 8 is a flowchart 800 showing an assembly method of the touch display panel module of the present invention. The flowchart of the assembly method of the touch display panel module of the present invention comprises the following steps:

Step 810: Provide a display panel module and a touch panel module, the display panel module has a first side, a second side opposite to the first side and a plurality of lateral sides between the first side and the second side;

Step 820: Continuously cover all edges around the first side of the display panel module with an anti-permeation tape;

Step 830: Form a layer of liquid optical adhesive between the first side of the display panel module and the touch panel module; and

Step 840: Solidify the layer of liquid optical adhesive in order to combine the display panel module and the touch panel module.

In contrast to the prior art, the touch display panel module of the present invention continuously covers all edges around the first side of the display panel module with the anti-permeation tape, and entirely or partially covers the lateral sides and the second side of the display panel module with the anti-permeation tape, such that when assembling the touch display panel module, the liquid optical adhesive cannot permeate inside through joint areas outside the display panel module. The assembly method of the touch display panel module of the present invention can prevent the liquid optical adhesive from permeating into gaps between the display panel and the backlight module due to the capillary phenomenon, and further increases assembly yield rate and efficiency of the touch display panel module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display panel module, comprising:
a display panel module for displaying images, and the display panel module has a first side, a second side opposite to the first side and a plurality of lateral sides between the first side and the second side;
a touch panel module arranged above the first side of the display panel module for sensing touch input; and
a combining unit, comprising:
an anti-permeation tape continuously covering on at least one of the edges around the first side of the display panel module; and
an optical adhesive layer formed between the display panel module and the touch panel module for combining the display panel module and the touch panel module.

2. The touch display panel module of claim 1, wherein the display panel module comprises:
a display panel;
a backlight module arranged behind the second side of the display panel module; and
a frame for positioning the display panel and the backlight module;
wherein the anti-permeation tape continuously covers all joints between the first side of the display panel and the frame.

3. The touch display panel module of claim 1, wherein the anti-permeation tape further covers on the lateral side and the second side of the display panel module.

4. The touch display panel module of claim 1, wherein the anti-permeation tape comprises a plurality sub tapes, and the plurality of sub tapes continuously covers all edges of the first side of the display panel module.

5. The touch display panel module of claim 4, wherein joint areas between the plurality of sub tapes are arranged at positions different from four corner positions of the first side of the display panel module.

6. The touch display panel module of claim 4, wherein each two adjacent sub tapes are overlapped with each other at a joint area.

7. The touch display panel module of claim 1, wherein an accommodation space is formed between the anti-permeation tape of the combining unit, the display panel module and the touch panel module, and the optical adhesive layer is formed inside the accommodation space.

8. The touch display panel module of claim 1, wherein the combining unit further comprises a plurality of spacers for forming an accommodation space between the display panel module and the touch panel module, and the optical adhesive layer is formed inside the accommodation space.

9. The touch display panel module of claim 8, wherein the plurality of spacers are arranged on the anti-permeation tape.

10. The touch display panel module of claim 8, wherein the plurality of spacers have gaps between them.

11. The touch display panel module of claim 1, wherein the optical adhesive layer is formed by solidifying liquid optical adhesive.

12. An assembly method of a touch display panel module, comprising:
providing a display panel module and a touch panel module, the display panel module having a first side, a second side opposite to the first side and a plurality of lateral sides between the first side and the second side;
continuously covering all edges around the first side of the display panel module with an anti-permeation tape;
forming a layer of liquid optical adhesive between the first side of the display panel module and the touch panel module; and
solidifying the layer of liquid optical adhesive in order to combine the display panel module and the touch panel module.
